(19) United States
(12) Patent Application Publication
(10) Pub. No.: US 2010/0188632 A1
(43) Pub. Date: Jul. 29, 2010

(54) LIQUID CRYSTAL DISPLAY PANEL

(76) Inventors: Keiji Takahashi, Osaka (JP); Shingo Johgan, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/677,362

(22) PCT Filed: Jun. 19, 2008
(86) PCT No.: PCT/JP2008/001586

§ 371 Date: Mar. 10, 2010

(30) Foreign Application Priority Data
Sep. 13, 2007 (JP) 2007-238357

(51) Int. Cl. G02F 1/1339

(52) U.S. Cl. 349/155

(57) ABSTRACT

A liquid crystal display panel (30a) includes a pair of substrates (10, 20a) arranged facing each other, a liquid crystal layer (25) provided between the pair of substrates (10, 20a), and a sealing member (15) configured to bond the pair of substrates (10, 20a) with each other while maintaining a predetermined gap between the pair of substrates (10, 20a), and enclose the liquid crystal layer (25). One (20a) of the substrates includes a color filter (13) in which a plurality of color layers (13a, 13b, 13c) of at least three colors are arranged, and column-like spacers (14) which are provided, standing on the color layer (13c) of a predetermined one color included in the color filter (13) and supporting the other substrate (10). The sealing member (15) is provided, coinciding with an underlying layer (13ca) formed of the same material as that of the color layer (13c) on which the column-like spacers (14) stand and in the same layer in which the color layer (13c) on which the column-like spacers (14) stand is formed.

### TECHNICAL FIELD

The present invention relates to liquid crystal display panels, and more particularly, to the structure of color filter substrates included in liquid crystal display panels.

### BACKGROUND ART

In liquid crystal display panels, a pair of substrates arranged facing each other are joined with each other via a sealing member for enclosing a liquid crystal layer. A spacer is interposed between the pair of substrates so that the substrates are held and separated with a predetermined gap therebetween.

For example, PATENT DOCUMENT 1 describes a liquid crystal display panel including a normal sealing resin corresponding to the sealing member formed at a position coinciding with a frame-like black matrix, and a dummy sealing resin formed outside the normal sealing resin, in which the diameter of a fiber-like spacer contained in the dummy sealing resin is the sum of the diameter of a fiber spacer contained in the normal sealing resin and a dimension corresponding to the thickness of the frame-like black matrix. PATENT DOCUMENT 1 also describes that, in this liquid crystal display panel, a non-uniform gap (non-uniform cell thickness) occurring at a periphery of the frame-like black matrix can be reduced.

### CITATION LIST

### Patent Document

PATENT DOCUMENT 1: Japanese Patent Laid-Open Publication No. 2003-107498

### SUMMARY OF THE INVENTION

### Technical Problem

FIG. 7 is a cross-sectional view of a conventional liquid crystal display panel 130a.

The liquid crystal display panel 130a includes an active matrix substrate 110 and a color filter substrate 120a arranged facing each other, a liquid crystal layer 125 provided between the substrates 110 and 120a, and a frame-like sealing member 115 for bonding the substrates 110 and 120a while enclosing the liquid crystal layer 125.

The color filter substrate 120a includes a grid-like black matrix 112a provided in a display region, a frame-like light shielding layer 112b provided in a frame region located at an outer peripheral portion of the display region, a color filter 113a including a red layer 113aa, a green layer 113ba and a blue layer 113ca provided between each grid bar of the black matrix 112a, and column-like spacers 114 protruding from the blue layer 113ca toward the active matrix substrate 110.

Here, the sealing member 115 contains spherical spacers for maintaining a predetermined gap between the active matrix substrate 110 and the color filter substrate 120a. Moreover, the column-like spacer 114 has an upper end abutting on the active matrix substrate 110 to support the active matrix substrate 110, thereby maintaining the predetermined gap between the substrates 110 and 120a.

FIG. 8 shows another liquid crystal display panel 130b in which a color filter 113b including a red layer 113ab, a green layer 113bb and a blue layer 113cb is formed thicker than the color filter 113a of the liquid crystal display panel 130a of FIG. 7. Therefore, in the liquid crystal display panel 130b, as shown in FIG. 8, a gap (i.e., cell thickness) between an active matrix substrate 110 and a color filter substrate 120b in the display region is maintained by column-like spacers 114 which have the same height as that of those of the liquid crystal display panel 130a. Therefore, for example, the active matrix substrate 110 may be deformed into a convex shape in the display region, resulting in a non-uniform cell thickness.

FIG. 9 shows another liquid crystal display panel 130c in which a color filter 113c including a red layer 113ac, a green layer 113bc and a blue layer 113cc is formed thinner than the color filter 113a of the liquid crystal display panel 130a of FIG. 7. Therefore, in the liquid crystal display panel 130c, as shown in FIG. 9, the cell thickness in the display region is maintained by column-like spacers 114 which have the same height as that of those of the liquid crystal display panel 130a as in the liquid crystal display panel 130b. Therefore, the active matrix substrate 110 may be deformed into a concave shape in the display region, so that a gap between an active matrix substrate 110 and a color filter substrate 120c in the display region may be reduced, resulting in a non-uniform, cell thickness. Moreover, when a surface of the liquid crystal display panel 130c is locally pressed in a low-temperature environment (e.g., −30° C. to −10° C.), the liquid crystal layer 125 may contract due to low temperature and may not follow deformation or restoration of the substrates themselves. In this case, a vacuum bubble called a low-temperature impact bubble may be formed in the liquid crystal display panel 130c.

Moreover, there is a so-called One Drop Fill (ODF) method in which a liquid crystal material is dropped onto a surface of one of the active matrix substrate and the color filter substrate before the substrates are bonded with each other via a sealing member formed in the shape of a closed frame. In this method, a predetermined volume surrounded by the sealing member needs to be filled with exactly the same volume of the liquid crystal material. Therefore, the cell thickness tends to be non-uniform because of a variation in the thickness of a color layer and a variation in the amount of the dropped liquid crystal material which forms the liquid crystal layer.

The present invention has been made in view of the aforementioned problems. It is an object of the present invention to reduce the occurrence of a non-uniform cell thickness which is caused by a variation in the thickness of a color layer included in the color filter.

### Solution to the Problem

To achieve the object, in the present invention, a sealing member is provided, coinciding with an underlying layer which is formed of the same material as that for a color layer on which column-like spacers are formed and in the same layer in which the color layer is formed, or a plurality of underlying layers which are formed of the same materials as those for respective corresponding color layers and in the same layers in which the respective corresponding color layers are formed.

Specifically, a liquid crystal display panel according to the present invention includes a pair of substrates arranged facing each other, a liquid crystal layer provided between the pair of substrates, and a sealing member configured to bond the pair of substrates with each other while maintaining a predetermined gap between the pair of substrates, and enclose the liquid crystal layer. One of the substrates includes a color filter in which a plurality of color layers of at least three colors are arranged, and column-like spacers which are provided, standing on the color layer of a predetermined one color included in the color filter and supporting the other substrate. The sealing member is provided, coinciding with an underlying layer formed of the same material as that of the color layer on which the column-like spacers stand and in the same layer in which the color layer on which the column-like spacers stand is formed.

With the aforementioned configuration, the color layer on which the column-like spacers are provided and the underlying layer for the sealing member are formed of the same material and in the same layer. Therefore, even if there is a variation in the thickness of the color layer on which the column-like spacers are provided, a position of a surface of the sealing member abutting on the other substrate is moved by a distance corresponding to the variation in the thickness of the color layer. Specifically, if the thickness of the color layer on which the column-like spacers are provided is reduced, the thickness of the underlying layer for the sealing member is also reduced, and therefore, the position of the surface of the sealing member abutting on the other substrate is moved closer to the one substrate by a distance corresponding to the reduction in the thickness of the color layer. As a result, the gap between the pair of the substrates is reduced, the amount of the liquid crystal material for the liquid crystal layer which should be supplied to the inside of the sealing member is reduced. Therefore, a shortage of the liquid crystal material between the pair of the substrates is avoided, whereby the occurrence of a non-uniform cell thickness is reduced. Moreover, if the thickness of the color layer on which the column-like spacers are provided is increased, the thickness of the underlying layer for the sealing member is also increased, and therefore, the position of the surface of the sealing member abutting on the other substrate is moved away from the one substrate by a distance corresponding to the increase in the thickness of the color layer. As a result, the gap between the pair of the substrates is increased, the amount of the liquid crystal material for the liquid crystal layer which should be supplied to the inside of the sealing member is increased. Therefore, an excess of the liquid crystal material between the pair of the substrates is avoided, whereby the occurrence of a non-uniform cell thickness is reduced. Therefore, the occurrence of a non-uniform cell thickness which is caused by a variation in the thickness of the color layer included in the color filter can be reduced.

Moreover, a liquid crystal display panel according to the present invention includes a pair of substrates arranged facing each other, a liquid crystal layer provided between the pair of substrates, and a sealing member configured to bond the pair of substrates with each other while maintaining a predetermined gap between the pair of substrates, and enclose the liquid crystal layer. One of the substrates includes a color filter in which a plurality of color layers of at least three colors are arranged, and column-like spacers which are provided, standing on the color filter and supporting the other substrate. The sealing member is provided, coinciding with a plurality of underlying layers formed of the same materials as those for the respective corresponding color layers and in the same layers in which the respective corresponding color layers are formed, and extending in parallel with each other.

With the aforementioned configuration, the sealing member coincides with the plurality of underlying layers formed of the same materials as those for the respective corresponding color layers and in the same layers in which the respective corresponding color layers are provided. Therefore, even if there is a variation in the thickness of any of the color layers included in the color filter, a position of a surface of the sealing member abutting on the other substrate is moved by a distance corresponding to the thickness variation. Specifically, in an arrangement of RGB pixels, if the thickness of a red layer is reduced, the thickness of the underlying layer formed of the same material as that for the red layer and in the same layer in which the red layer is provided is also reduced. Therefore, the position of the sealing member abutting on the other substrate is moved closer to the one substrate by a distance corresponding to the reduction in the thickness of the red layer. As a result, the gap between the pair of substrates is reduced, and therefore, the amount of the liquid crystal material for the liquid crystal layer which should be supplied to the inside of the sealing member is reduced. Therefore, a shortage of the liquid crystal material between the pair of substrates is avoided, whereby the occurrence of a non-uniform cell thickness is reduced. Moreover, if the thickness of the red layer is increased, the thickness of the underlying layer formed of the same material as that for the red layer and in the same layer in which the red layer is provided is also increased. Therefore, the position of the sealing member abutting on the other substrate is moved away from the one substrate by a distance corresponding to the increase in the thickness of the red layer. As a result, the gap between the pair of substrates is increased, and therefore, the amount of the liquid crystal material for the liquid crystal layer which should be supplied to the inside of the sealing member is increased. Therefore, an excess of the liquid crystal material between the pair of substrates is avoided, whereby the occurrence of a non-uniform cell thickness is reduced. Therefore, the occurrence of a non-uniform cell thickness which is caused by a variation in the thickness of a color layer included in the color filter can be reduced.

The sealing member may be in the shape of a frame.

With the aforementioned configuration, the sealing member is in the shape of a frame, and therefore, the occurrence of a non-uniform cell thickness which is caused by a variation in the thickness of a color layer included in the color filter is reduced in a liquid crystal display panel which is fabricated by the ODF method.

The one of the pair of substrates may include a black matrix provided between each of the color layers, and a light shielding layer which is a frame-like extended portion of the black matrix provided on a surface closer to the substrate of the underlying layer or layers.

With the aforementioned configuration, the light shielding layer which is a frame-like extended portion of the black matrix provided on a surface closer to the substrate of the underlying layer or layers, is provided, and therefore, an outer peripheral portion of the display region in which the plurality of color layers are arranged maintains the ability to shield the frame region from light.

The plurality of color layers may include a red layer, a green layer and a blue layer and may be arranged in a matrix.

With the aforementioned configuration, the plurality of color layers including a red layer, a green layer and a blue layer are arranged in a matrix, and therefore, the one of the substrates is specifically, for example, a color filter substrate in which, RGB color layers are arranged in stripes.

The sealing member may contain particulate spacers.

With the aforementioned configuration, surfaces closer to the liquid crystal layer of the pair of substrates abut on the particulate spacers, and therefore, specifically, the predetermined gap is maintained between the pair of substrates.

The plurality of color layers may include a red layer, a green layer and a blue layer, and the color layer on which the column-like spacers stand may be the blue layer.

With the aforementioned configuration, the column-like spacers are provided on the blue layer, and therefore, the column-like spacers are caused to be less conspicuous than when the column-like spacers are provided on the red layer or the green layer.

Each of the underlying layers may be provided, extending in a direction intersecting an extending direction of the sealing member.

With the aforementioned configuration, each of the underlying layers intersects the sealing member, and therefore, specifically, the sealing member coincides with the underlying layers.

### ADVANTAGES OF THE INVENTION

According to the present invention, a sealing member is provided, coinciding with an underlying layer which is formed of the same material as that for a color layer on which column-like spacers are formed and in the same layer in which the color layer is formed, or a plurality of underlying layers which are formed of the same materials as those for respective corresponding color layers and in the same layers in which the respective corresponding color layers are formed. Therefore, the occurrence of a non-uniform cell thickness which is caused by a variation in the thickness of a color layer included in the color filter can be reduced.

### BRIEF DESCRIPTION OF THE DRAWINGS

FIG. 1 is a cross-sectional view of a liquid crystal display panel 30a according to Embodiment 1.

FIG. 2 is a top view of a frame region of a color filter substrate 20a included in the liquid crystal display panel 30a.

FIG. 3 is a top view of a liquid crystal display panel 30b according to Embodiment 2.

FIG. 4 is a top view of a region A of a color filter substrate 20b included in the liquid crystal display panel 30b.

FIG. 5 is a top view of a region B of the color filter substrate 20b included in the liquid crystal display panel 30b.

FIG. 6 a top view of a display region of the color filter substrate 20b included in the liquid crystal display panel 30b.

FIG. 7 is a cross-sectional view of a conventional liquid crystal display panel 130a.

FIG. 8 is a cross-sectional view of a conventional liquid crystal display panel 130b.

FIG. 9 is a cross-sectional view of a conventional liquid crystal display panel 130c.

### DESCRIPTION OF REFERENCE CHARACTERS

10 Active Matrix Substrate (Other Substrate)
12a Black Matrix
12b Light Shielding Layer
13 Color Filter
13a Red Layer (Color Layer)
13b Green Layer (Color Layer)
13c Blue Layer (Color Layer)
13ca, 13ab, 13bb, 13cb, 13ac, 13bc, 13cc Underlying Layer
14 Column-like Spacer
15 Sealing Member
15a Particulate Spacer
20a, 20b Color Filter Substrate (One Substrate)
25 Liquid Crystal Layer
30a, 30b Liquid Crystal Display Panel

### DESCRIPTION OF EMBODIMENTS

Embodiments of the present invention will be described hereinafter with reference to the accompanying drawings. Note that the present invention is not limited to the embodiments described below.

### Embodiment 1 of the Invention

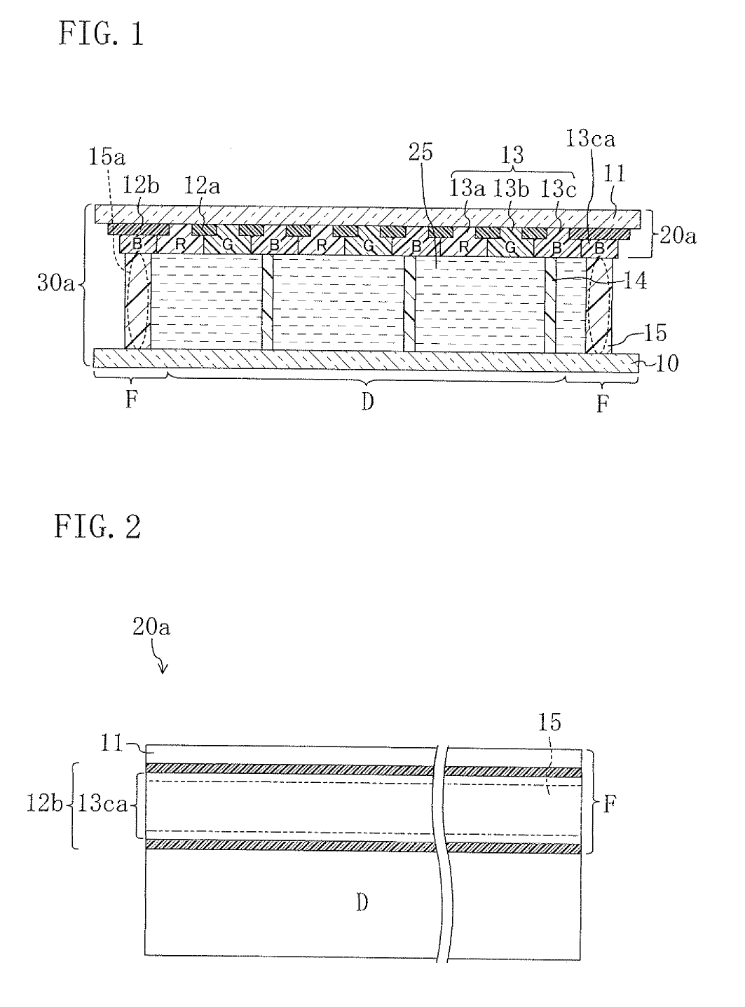

FIGS. 1 and 2 show a liquid crystal display panel according to Embodiment 1 of the present invention. Specifically, FIG. 1 is a cross-sectional view of a liquid crystal display panel 30a of this embodiment, and FIG. 2 is a top view of a frame region of a color filter substrate 20a included in the liquid crystal display panel 30a.

As shown in FIG. 1, the liquid crystal display panel 30a includes an active matrix substrate 10 and a color filter substrate 20a which are provided as a pair of substrates arranged facing each other, a liquid crystal layer 25 provided between the active matrix substrate 10 and the color filter substrate 20a, and a sealing member 15 for bonding the active matrix substrate 10 with the color filter substrate 20a while enclosing the liquid crystal layer 25.

The active matrix substrate 10 includes, for example, a plurality of gate lines (not shown) provided on an insulating substrate, extending in parallel with each other, a plurality of source lines (not shown) provided extending in parallel with each other and in a direction perpendicular to the gate lines, a plurality of TFTs (thin film transistors, not shown) provided at intersections of the gate lines and the source lines, and a plurality of pixel electrodes (not shown) coupled to the drain electrodes of the respective corresponding TFTs.

As shown in FIG. 1, the color filter substrate 20a includes an insulating substrate 11, a grid-like black matrix 12a and a frame-like light shielding layer 12b provided on the insulating substrate 11, a color filter 13 including a red layer 13a, a green layer 13b and a blue layer 13c provided between each grid bar of the black matrix 12a, a common electrode (not shown) provided covering the color filter 13, and column-like spacers 14 provided protruding from the blue layer 13c via the common electrode toward the active matrix substrate 10. Here, in the color filter substrate 20a, the color filters 13 in which the red layer 13a, the green layer 13b and the blue layer 13c are arranged in a matrix forms a display region. D, and the light shielding layer 12b provided at an outer peripheral portion of the display region D and a portion further outside the light shielding layer 12b form a frame region F. Note that, in the active matrix substrate 10, the pixel electrodes arranged in a matrix form the display region D.

Moreover, as shown in FIG. 2, an underlying layer 13ca for providing the sealing member 15 is provided on the light shielding layer 12b. The underlying layer 13ca is formed of the same material as that for the blue layer 13c and is formed in the same layer in which the blue layer 13c is formed, and therefore, has the same thickness as that of the blue layer 13c.

The sealing member 15 contains spherical spacers 15a (particulate spacers), such as plastic beads or the like, whose spherical surfaces abut on the active matrix substrate 10 and the color filter substrate 20a. Note that, in FIG. 1, the spherical spacer 15a is shown in a deformed shape, i.e., an ellipse. The spherical spacer 15a may be in the shape of a cylinder having a diameter and a height which are equal to each other.

The liquid crystal layer 25 is formed of a nematic liquid crystal material having an electro-optical property or the like.

In the liquid crystal display panel 30a having the aforementioned configuration, in each pixel, which is an minimum unit of an image, when a gate signal is transferred from a gate line to the gate electrode of a TFT, so that the TFT is turned on, a source signal is transferred from a source line to the source electrode of the TFT, and predetermined charge is written via the semiconductor layer and the drain electrode of the TFT to the pixel electrode. In this case, a potential difference occurs between each pixel electrode of the active matrix substrate 10 and the common electrode of the counter substrate 20a, and therefore, a predetermined voltage is applied to the liquid crystal layer 25. Moreover, in the liquid crystal display panel 30a, an image is displayed by changing the magnitude of the voltage applied to the liquid crystal layer 25 to change the alignment state of the liquid crystal layer 25 and thereby adjust the light transmittance of the liquid crystal layer 25.

Next, a method for fabricating the liquid crystal display panel 30a of this embodiment will be described. The fabrication method of this embodiment includes a substrate fabricating step, an alignment film forming step, a sealing member applying step, a liquid crystal dropping step, a joining step and a sealing member curing step.

<Substrate Fabricating Step>

—Active Matrix Substrate Fabricating Step—

Initially, a metal film made of aluminum or the like is formed on an entirety of a glass substrate having a thickness of about 0.7 mm by sputtering. Thereafter, patterning is performed by photolithography to form gate lines and the gate electrodes of TFTs.

Next, a silicon nitride film and the like are formed, by CVD (Chemical Vapor Deposition) or the like, on an entirety of the substrate on which the gate lines and the gate electrodes have been formed, thereby forming a gate insulating film. Moreover, an intrinsic amorphous silicon film and a phosphorus-doped n⁺ amorphous silicon film are successively formed, by CVD, on an entirety of the substrate on which the gate insulating film has been formed. Thereafter, patterning is performed by photolithography to form an island-like pattern on the gate electrode. As a result, a semiconductor layer is formed which includes the intrinsic amorphous silicon layer and the n⁺ amorphous silicon layer.

Thereafter, a metal film made of titanium or the like is formed, by sputtering, on an entirety of the substrate on which the semiconductor layer has been formed. Thereafter, patterning is performed by photolithography to form source lines, and the source and drain electrodes of TFTs.

Next, the n⁺ amorphous silicon layer of the semiconductor layer is etched using the source and drain electrodes as a mask, to form a pattern of channel portions. As a result, TFTs are formed.

Moreover, a film made of a photosensitive acrylic resin or the like is formed, by spin coating, on an entirety of the substrate on which the TFTs have been formed. Thereafter, patterning is performed by photolithography to form contact holes on the respective drain electrodes, thereby forming an interlayer insulating film.

Thereafter, an ITO (Indium Tin Oxide) film is formed, by sputtering, on an entirety of the substrate on the interlayer insulating film. Thereafter, patterning is performed by photolithography to form pixel electrodes.

Thus, the active matrix substrate 10 can be fabricated.

—Color Filter Substrate Fabricating Step—

Initially, a black colored photosensitive resist material or the like is applied onto an entirety of a glass substrate (the insulating substrate 11) having a thickness of about 0.7 mm. Thereafter, patterning is performed by photolithography to form the black matrix 12a and the light shielding layer 12b having a thickness of about 1.0 μm. Note that the light shielding layer 12b having a width of about 1 mm to about 2 mm.

Next, for example, a red, green or blue colored photoresist material or the like is applied between each grid bar of the black matrix 12a. Thereafter, patterning is performed by photolithography to form a color layer having a selected color (e.g., the red layer 13a) and having a thickness of about 0.8 μm to about 2.5 μm. Moreover, a similar process is repeated for the other two colors to form color layers having the other two colors (e.g., the green layer 13b, the blue layer 13c and the underlying layer 13ca) having a thickness of about 0.8 μm to about 2.5 μm. Note that the underlying layer 13ca has a width of about 1 mm.

Moreover, for example, an ITO film having a thickness of about 100 nm is formed on the color filter 13 including the red layer 13a, the green layer 13b and the blue layer 13c and the underlying layer 13ca by sputtering to form the common electrode.

Finally, a photosensitive acrylic resin or the like is applied onto an entirety of the substrate on which the common electrode has been formed. Thereafter, patterning is performed by photolithography to form the column-like spacers 14 having a height of about 3 μm to about 5 μm on the blue layer 13c.

Thus, the color filter substrate 20a can be fabricated.

<Alignment Film Forming Step>

Initially, the active matrix substrate 10 fabricated in the active matrix substrate fabricating step and the color filter substrate 20a fabricated in the color filter substrate fabricating step are washed with pure water or the like.

Next, a polyimide resin is applied onto a surface of each of the washed active matrix substrate 10 and color filter substrate 20a by a printing method, followed by a rubbing process, to form an alignment film.

<Sealing Member Applying Step>

For example, a thermal and UV curing acrylic-epoxy resin including the spherical spacers 15a having a diameter of about 3 μm to about 5 μm is applied (drawn), using a dispenser or the like, onto one (e.g., the color filter substrate 20a) of the active matrix substrate 10 and the color filter substrate 20a on which the alignment film has been formed in the alignment film forming step so that the resin coincides with the frame-like underlying layer 13ca as shown in FIG. 2.

<Liquid Crystal Dropping Step>

A liquid crystal material (25) is dropped onto the display region D of the color filter substrate 20a on which the acrylic-epoxy resin (the sealing member 15) has been applied in the sealing member applying step.

<Joining Step>

Initially, the color filter substrate 20a on which the liquid crystal material (25) has been dropped in the liquid crystal dropping step and the active matrix substrate 10 on which the alignment film has been formed in the alignment film forming step are joined with each other in vacuum in a manner which allows the display regions D of them to coincide with each other.

Next, the active matrix substrate 10 and the color filter substrate 20a thus joined with each other are exposed to the atmosphere so that pressure is applied on the surfaces of the active matrix substrate 10 and the color filter substrate 20a.

<Sealing Member Curing Step>

The active matrix substrate 10 and the color filter substrate 20a which have been joined with each other in the joining step are subjected to UV irradiation and baking, whereby the sealing member 15 interposed between the active matrix substrate 10 and the color filter substrate 20a is cured to enclose the liquid crystal layer 25.

Thus, the liquid crystal display panel 30a can be fabricated.

As described above, according to the liquid crystal display panel 30a of this embodiment, the blue layer 13c on which the column-like spacers 14 are provided and the underlying layer 13ca for the sealing member 15 are formed of the same material and in the same layer. Therefore, if there is a variation in the thickness of the blue layer 13c on which the column-like spacers 14 are provided, a position of the surface of the sealing member 15 abutting on the active matrix substrate 10 is moved by a distance corresponding to the variation in the thickness of the blue layer 13c. Specifically, if the thickness of the color layer 13c on which the column-like spacer 14s are formed is reduced, the thickness of the underlying layer 13ca for the sealing member 15 is also reduced, and therefore, the position of the surface of the sealing member 15 abutting on the active matrix substrate 10 is moved closer to the color filter substrate 20a by a distance corresponding to the reduction in the thickness of the blue layer 13c. As a result, a gap between the active matrix substrate 10 and the color filter substrate 20a is reduced, and therefore, the amount of the liquid crystal material for the liquid crystal layer 25 which should be supplied to the inside of the sealing member 15 is reduced. Therefore, a shortage of the liquid crystal material between the active matrix substrate 10 and the color filter substrate 20a is avoided, whereby the occurrence of a non-uniform cell thickness can be reduced. Moreover, if the thickness of the blue layer 13c on which the column-like spacers 14 are formed is increased, the thickness of the underlying layer 13ca for the sealing member 15 is also increased, and therefore, the position of the surface of the sealing member 15 abutting on the active matrix substrate 10 is moved away from the color filter substrate 20a by a distance corresponding to the increase in the thickness of the blue layer 13c. As a result, the gap between the active matrix substrate 10 and the color filter substrate 20a is increased, and therefore, the amount of the liquid crystal material for the liquid crystal layer 25 which should be supplied to the inside of the sealing member 15 is increased. Therefore, an excess of the liquid crystal material between the active matrix substrate 10 and the color filter substrate 20a is avoided, whereby the occurrence of a non-uniform cell thickness can be reduced. Therefore, the occurrence of a non-uniform cell thickness which is caused by a variation in the thickness of the blue layer 13c included in the color filter 13 can be reduced.

Moreover, according to the liquid crystal display panel 30a of this embodiment, the column-like spacers 14 are provided on the blue layer 13c, and therefore, it is possible to cause the column-like spacers 14 on the color filter 13 to be less conspicuous than when the column-like spacers 14 are provided on the red layer 13a or the green layer 13b.

Moreover, according to the liquid crystal display panel 30a of this embodiment, the light shielding layer 12b which is a frame-like extended portion of the black matrix 12a is provided on a surface closer to the substrate of the underlying layer 13ca on which the sealing member 15 is provided. Therefore, the light shielding property of the frame region F at the peripheral portion of the display region D can be maintained.

Moreover, according to the liquid crystal display panel 30a of this embodiment, the shortage of the liquid crystal material between the active matrix substrate 10 and the color filter substrate 20a is avoided, whereby the formation of a low-temperature impact bubble can be reduced.

Moreover, it has been illustrated above that the column-like spacers 14 are provided on the blue layer 13c in the liquid crystal display panel 30a of this embodiment. Alternatively, the column-like spacers 14 may be provided on the green layer 13b. In this case, if the underlying layer in the frame region F is formed of the same material as that for the green layer 13b and in the same layer in which the green layer 13b is formed, the occurrence of a non-uniform cell thickness which is caused by a variation in the thickness of the green layer 13b included in the color filter 13 can be reduced. Moreover, the column-like spacers 14 may be provided on the red layer 13a. In this case, if the underlying layer in the frame region F is formed of the same material as that for the red layer 13a and in the same layer in which the red layer 13a is formed, the occurrence of a non-uniform cell thickness which is caused by a variation in the thickness of the red layer 13a included in the color filter 13 can be reduced.

### Embodiment 2 of the Invention

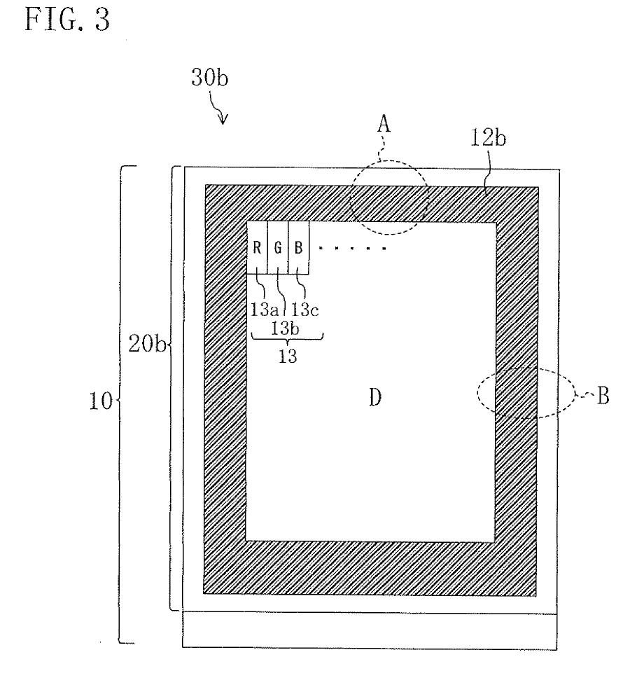

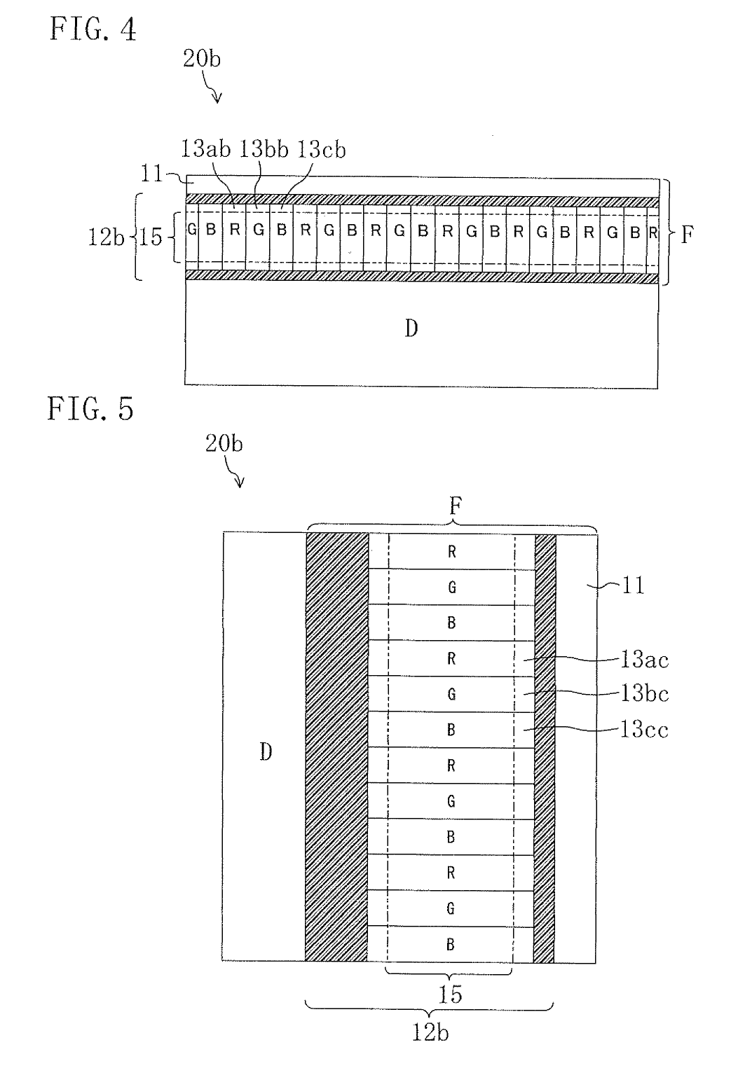

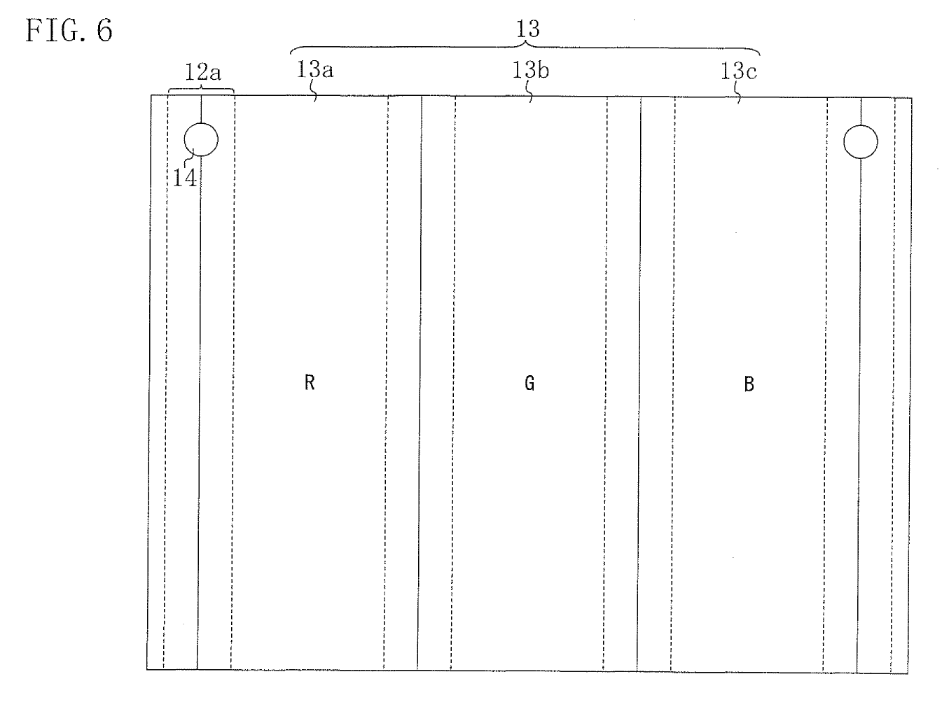

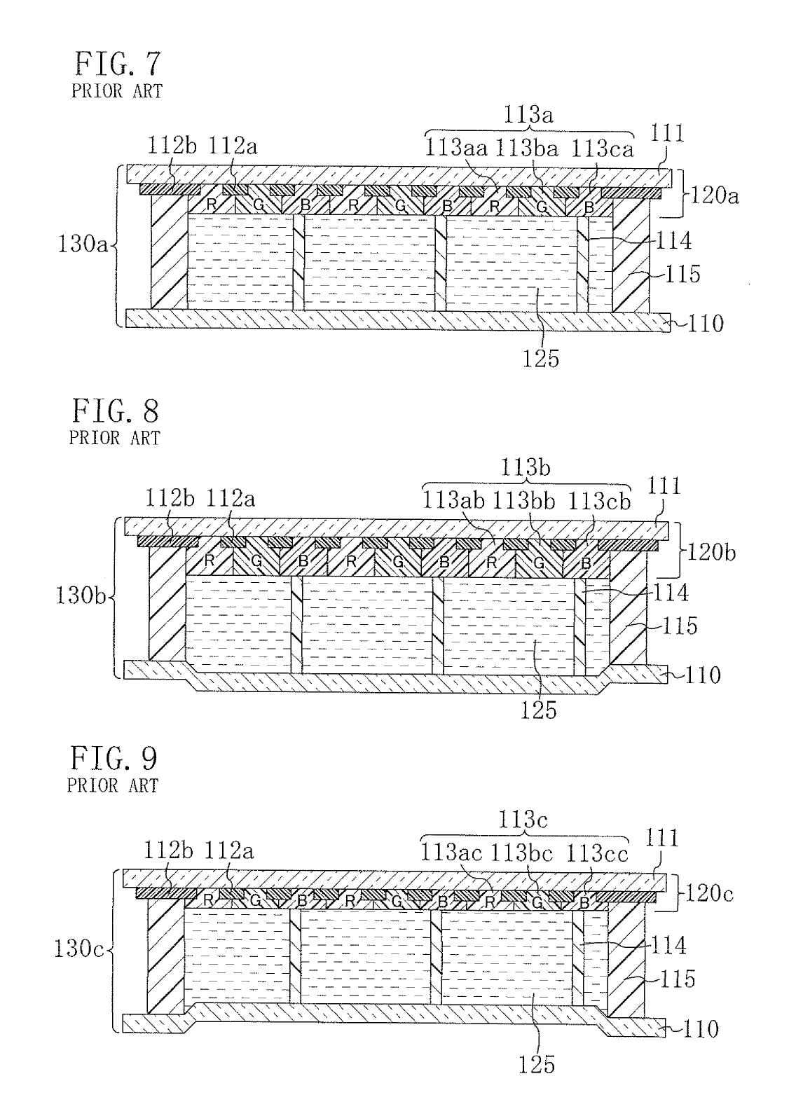

FIGS. 3-6 show a liquid crystal display panel according to Embodiment 2 of the present invention. Specifically, FIG. 3 is a top view of a liquid crystal display panel 30b of this embodiment. FIG. 4 is a top view of a region A of a color filter substrate 20b included in the liquid crystal display panel 30b. FIG. 5 is a top view of a region B of the color filter substrate 20b. FIG. 6 is a top view of a display region of the color filter substrate 20b. Note that, in the following embodiment, the same portions as those of FIGS. 1 and 2 are indicated by the same reference characters and will not be described in detail.

As shown in FIG. 3, the liquid crystal display panel 30b includes an active matrix substrate 10 and a color filter substrate 20b arranged facing each other, a liquid crystal layer 25 provided between the active matrix substrate 10 and the color filter substrate 20b, and a sealing member 15 for bonding the active matrix substrate 10 with the color filter substrate 20b while enclosing the liquid crystal layer 25.

As shown in FIGS. 3-6, the color filter substrate 20b includes an insulating substrate 11, a grid-like black matrix 12a and a frame-like light shielding layer 12b provided on the insulating substrate 11, a color filter 13 including a red layer 13a, a green layer 13b and a blue layer 13c provided between each grid bar of the black matrix 12a, a common electrode (not shown) provided covering the color filter 13, and column-like spacers 14 provided protruding from the color layer 13 via the common electrode toward the active matrix substrate 10.

Moreover, a plurality of underlying layers 13ab, 13bb and 13cb (see FIG. 4) and 13ac, 13bc and 13cc (see FIG. 5) on which the sealing member 15 is provided are provided on the light shielding layer 12b. Here, as shown in FIGS. 4 and 5, the underlying layers 13ab, 13bb, 13cb, 13ac, 13bc and 13cc are provided, extending in a direction intersecting (perpendicular to) the sealing member 15. Moreover, the underlying layers 13ab and 13ac are formed of the same material as that for the red layer 13a and in the same layer in which the red layer 13a is formed, and therefore, has the same thickness as that of the red layer 13a. The underlying layers 13bb and 13bc are formed of the same material as that for the green layer 13b and in the same layer in which the green layer 13b is formed, and therefore, has the same thickness as that of the green layer 13b. The underlying layers 13cb and 13cc are formed of the same material as that for the blue layer 13c and in the same layer in which the blue layer 13c is formed, and therefore, has the same thickness as that of the blue layer 13c. Note that the underlying layers 13ab, 13bb, 13cb, 13ac, 13bc and 13cc each has a size of, for example, about 30 μm to about 50 μm×about 1 mm.

The liquid crystal display panel 30b of this embodiment can be fabricated by the fabrication method of Embodiment 1 in which a different underlying layer pattern is used, and therefore, the method will not be described in detail.

As described above, according to the liquid crystal display panel 30b of this embodiment, the sealing member 15 coincides with the underlying layers 13ab and 13ac formed of the same material as that for the red layer 13a and in the same layer in which the red layer 13a is formed, the underlying layers 13bb and 13bc formed of the same material as that for the green layer 13b and in the same layer in which the green layer 13b is formed, and the underlying layers 13cb and 13cc formed of the same material as that for the blue layer 13e and in the same layer in which the blue layer 13c is formed. Therefore, if there is a variation in the thickness of any of the red layer 13a, the green layer 13b and the blue layer 13c included in the color filter 13, a position of an upper end (abutment surface) of the sealing member 15 abutting on the active matrix substrate 10 is moved by a distance corresponding to the thickness variation. Specifically, if the thickness of the red layer 13a is reduced, the underlying layers 13ab and 13ac formed of the same material as that for the red layer 13a and in the same layer in which the red layer 13a is formed is also reduced, and therefore, the position of the abutment surface of the sealing member 15 with the active matrix substrate 10 is moved closer to the color filter substrate 20b by a distance corresponding to the reduction in the thickness of the red layer 13a (e.g., about ⅓ of the reduction in the thickness of the red layer 13a). As a result, a gap between the active matrix substrate 10 and the color filter substrate 20b is reduced, and therefore, the amount of the liquid crystal material for the liquid crystal layer 25 which should be supplied to the inside of the sealing member is reduced. Therefore, a shortage of the liquid crystal material between the active matrix substrate 10 and the color filter substrate 20b is avoided, whereby the occurrence of a non-uniform cell thickness can be reduced. Moreover, if the thickness of the red layer 13a is increased, the underlying layers 13ab and 13ac formed of the same material as that for the red layer 13a and in the same layer in which the red layer 13a is formed is also increased, and therefore, the position of the abutment surface of the sealing member 15 with the active matrix substrate 10 is moved away from the color filter substrate 20b by a distance corresponding to the increase in the thickness of the red layer 13a (e.g., about ⅓ of the increase in the thickness of the red layer 13a). As a result, the gap between the active matrix substrate 10 and the color filter substrate 20b is increased, and therefore, the amount of the liquid crystal material for the liquid crystal layer 25 which should be supplied to the inside of the sealing member is increased. Therefore, an excess of the liquid crystal material between the active matrix substrate 10 and the color filter substrate 20b is avoided, whereby the occurrence of a non-uniform cell thickness can be reduced. Therefore, the occurrence of a non-uniform cell thickness which is caused by a variation in the thickness of any of the red layer 13a, the green layer 13b and the blue layer 13c included in the color filter 13 can be reduced.

Moreover, according to the liquid crystal display panel 30b of this embodiment, the light shielding layer 12b which is a frame-like extended portion of the black matrix 12a is provided on surfaces closer to the substrate of the underlying layers 13ab, 13bb, 13cb, 13ac, 13bc and 13cc on which the sealing member 15 is provided. Therefore, the light shielding property of the frame region F at the peripheral portion of the display region D can be maintained.

Moreover, according to the liquid crystal display panel 30b of this embodiment, the shortage of the liquid crystal material between the active matrix substrate 10 and the color filter substrate 20b is avoided, whereby the formation of a low-temperature impact bubble can be reduced.

Moreover, in each of the aforementioned embodiments, the active matrix drive type liquid crystal display panel has been illustrated. Alternatively, the present invention is also applicable to passive matrix drive type liquid crystal display panels.

Moreover, in each of the aforementioned embodiments, the liquid crystal display panel including the color filter substrate having the stripe pattern has been illustrated. Alternatively, the present invention is also applicable to liquid crystal display panels including a color filter substrate having a delta pattern.

Moreover, in each of the aforementioned embodiments, the liquid crystal display panel including the color filter substrate having the three color (RGB) layers has been illustrated. Alternatively, the present invention is also applicable to liquid crystal display panels including a color filter substrate having four color layers (RGB layers and a white (W) layer or a yellow (Y) layer), and liquid crystal display panels including a color filter substrate having five color layers (the RGB layers, and a yellow (Y) layer and a cyan (C) layer).

Moreover, in each of the aforementioned embodiments, the liquid crystal display panel which is fabricated by the ODF method has been illustrated. Alternatively, the present invention is also applicable to liquid crystal display panels which are fabricated by fabricating an empty cell under room pressure and then injecting a liquid crystal material into between the substrates of the empty cell by a vacuum injection method.

### INDUSTRIAL APPLICABILITY

As described above, the present invention reduces the occurrence of a non-uniform cell thickness and therefore is useful for substantially all liquid crystal display panels.

1. A liquid crystal display panel comprising:
a pair of substrates arranged facing each other;
a liquid crystal layer provided between the pair of substrates; and
a sealing member configured to bond the pair of substrates with each other while maintaining a predetermined gap between the pair of substrates, and enclose the liquid crystal layer,
wherein
one of the substrates includes a color filter in which a plurality of color layers of at least three colors are arranged, and column-like spacers which are provided, standing on the color layer of a predetermined one color included in the color filter and supporting the other substrate, and
the sealing member is provided, coinciding with an underlying layer formed of the same material as that of the color layer on which the column-like spacers stand and in the same layer in which the color layer on which the column-like spacers stand is formed.

2. A liquid crystal display panel comprising:
a pair of substrates arranged facing each other;
a liquid crystal layer provided between the pair of substrates; and
a sealing member configured to bond the pair of substrates with each other while maintaining a predetermined gap between the pair of substrates, and enclose the liquid crystal layer,
wherein
one of the substrates includes a color filter in which a plurality of color layers of at least three colors are arranged, and column-like spacers which are provided, standing on the color filter and supporting the other substrate, and
the sealing member is provided, coinciding with a plurality of underlying layers formed of the same materials as those for the respective corresponding color layers and in the same layers in which the respective corresponding color layers are formed, and extending in parallel with each other.

3. The liquid crystal display panel of claim 1, wherein
the sealing member is in the shape of a frame.

4. The liquid crystal display panel of claim 1, wherein
the one of the pair of substrates includes a black matrix provided between each of the color layers, and a light shielding layer which is a frame-like extended portion of the black matrix provided on a surface closer to the substrate of the underlying layer or layers.

5. The liquid crystal display panel of claim 1, wherein
the plurality of color layers include a red layer, a green layer and a blue layer and are arranged in a matrix.

6. The liquid crystal display panel of claim 1, wherein
the sealing member contains particulate spacers.

7. The liquid crystal display panel of claim 1, wherein
the plurality of color layers include a red layer, a green layer and a blue layer, and
the color layer on which the column-like spacers stand is the blue layer.

8. The liquid crystal display panel of claim 2, wherein
each of the underlying layers is provided, extending in a direction intersecting an extending direction of the sealing member.

9. The liquid crystal display panel of claim 2, wherein
the sealing member is in the shape of a frame.

10. The liquid crystal display panel of claim 2, wherein
the one of the pair of substrates includes a black matrix provided between each of the color layers, and a light shielding layer which is a frame-like extended portion of the black matrix provided on a surface closer to the substrate of the underlying layer or layers.

11. The liquid crystal display panel of claim 2, wherein
the plurality of color layers include a red layer, a green layer and a blue layer and are arranged in a matrix.

12. The liquid crystal display panel of claim 2, wherein
the sealing member contains particulate spacers.
